(19) United States
(12) Patent Application Publication
(10) Pub. No.: US 2009/0307711 A1
(43) Pub. Date: Dec. 10, 2009

(54) INTEGRATING COMPUTATION AND COMMUNICATION ON SERVER ATTACHED ACCELERATORS

(75) Inventors: Rajaram B. Krishnamurthy, Wappingers Falls, NY (US); Thomas A. Gregg, Highland, NY (US)

Correspondence Address: CONNOLLY BOVE LODGE & HUTZ LLP, 1875 EYE STREET, N.W., SUITE 1100, WASHINGTON, DC, 20006, US

(73) Assignee: International Business Machines Corporation, Armonk, NY (US)

(21) Appl. No.: 12/133,543

(22) Filed: Jun. 5, 2008

(51) Int. Cl. G06F 13/00

(52) U.S. Cl. 719/313

(57) ABSTRACT

In a call-return-communicate scheme an OS/hypervisor/inter-partition shared memory usage is replaced by a software abstraction or mailbox router implemented on an accelerator which handles LPAR communication needs, thereby obviating the need to invoke the OS/hypervisor/inter-partition shared memory. By eliminating the need for the OS/hypervisor/shared memory, system latency is reduced by removing communication and hypervisor invocation time.

### BACKGROUND

The present invention relates to computer hardware and data transmission in particular. In many computing systems in use today, data from an address space or logical partition (LPAR) is communicated to an accelerator attached to an enterprise server, computed on the accelerator and then returned to the LPAR or address space. The address space or LPAR may then communicate these values to other address spaces or LPARs. Typically, the data is transferred without any change or it might be scaled or mapped to another value using a lookup table. This “call-return-communicate” structure is a common usage pattern in server attached accelerators. The trailing communication can happen in two ways; one-to-one and one-to-many. In a one-to-one communication pattern and as shown in FIG. 1, a single accelerator 240 returns a value to one LPAR/address space 210. The LPAR 210 then communicates a value to just one other LPAR2 220. In a one-to-many trailing communication pattern as shown in FIG. 1, LPAR1 210 makes a call to the accelerator 240 taking time A. The accelerator 240 computes and returns its output to LPAR1 210 taking time B for communication. LPAR1 210 then simultaneously communicates data values to LPAR2 220 and LPAR3 230 taking time T in each case. The total execution time for the call-return-communicate from LPAR1 is then (A+B+T) [Expression I]. Thus in a one-to-many trailing communication pattern, a single LPAR provides a value returned from an accelerator to multiple LPARs/Address spaces. An OS/hypervisor is usually engaged to communicate accelerator returned values to other LPARs or address spaces from an LPAR. OS/hypervisor operations, however, can add considerable latency to accelerator action even if inter-partition shared memory constructs are used. It is desirable, therefore, to reduce the latency inherent in conventional call-return and communication schemes.

### SUMMARY

The present invention is directed to a method and computer program product that integrates call-return and communication operations directly on an accelerator and obviates the need for OS/hypervisor calls or inter-partition shared memory. By removing the need for OS/hypervisor calls, latency in accelerator action is reduced thereby enhancing system performance. The method of the present invention comprises a software abstraction called a “mailbox router” operating on an accelerator. With this configuration, an LPAR that needs to communicate accelerator output values to other address spaces/LPARs, registers its communication needs with the mailbox router along with recipients of the accelerator function output. The recipients can be address spaces (AS) within an LPAR, an LPAR or another mailbox router input. This arrangement bypasses OS/hypervisor invocation and reduces latency by removing communication time and hypervisor invocation time. As depicted in FIG. 2, LPAR1 makes a call to the accelerator taking time A and the accelerator simultaneously returns values to LPAR1, LPAR2 and LPAR3 taking time U for each case. The total time for execution of the call-return-communicate from LPAR1 is (A+U) [Expression II] in FIG. 2. The total call-return-communicate execution time in FIG. 2 (Expression II) totally eliminates time B (from expression I). Moreover, time U (expression II) is engineered to be much less than T (expression I). This makes expression II of lower value than expression I and means that the total time for execution of call-return-communicate in FIG. 2 is less than the total time to execute a call-return-communicate in FIG. 1. The mailbox router in FIG. 2 can stream data values to LPARs 2 and 3 with pre-programmed qualities of service. The communication infrastructure from LPAR1 to LPAR2, LPAR3 in FIG. 1 across the OS/hypervisor usually lacks pre-programmed qualities of service and is not optimized for bulk data transmission. The communication infrastructure from LPAR1 to LPAR2, LPAR3 (FIG. 1) is usually designed for small messages required in inter-address-space communication and is not designed for bulk data transmission required in server acceleration environments. The present invention described in FIG. 2 is thus able to provide efficient communication over the prior-art of FIG. 1.

In one embodiment of the invention, a method of integrating communication operations comprises registering communication requirements and recipient data from an LPAR to inputs of a software abstraction operating on an accelerator function, said software abstraction comprising a mailbox router and said inputs comprising at least one of LPARs, address spaces and other mailbox routers; and outputting communications from the software abstraction to at least one of address spaces, LPARs and mailbox routers.

### BRIEF DESCRIPTION OF THE DRAWINGS

FIG. 1 is a schematic depicting a conventional call-return-communicate structure;

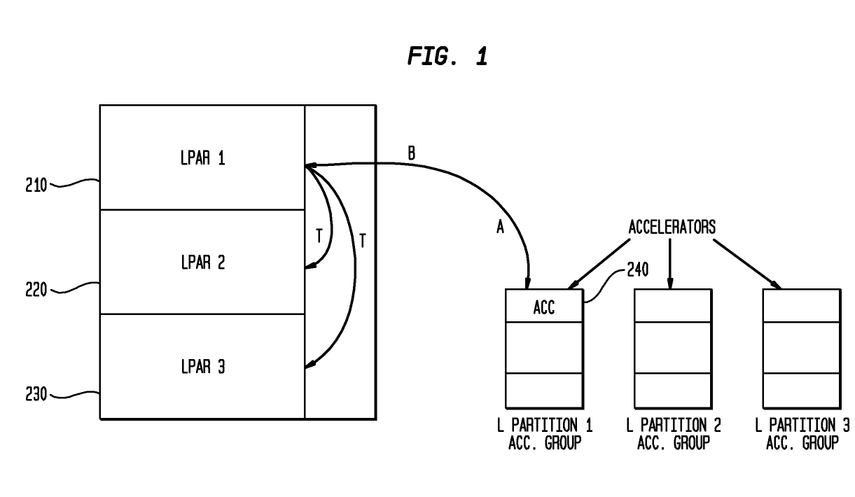

FIG. 2 is a high-level diagram depicting a communication scheme utilizing a mailbox router in accordance with an embodiment of the invention;

FIG. 3 is a high-level diagram depicting how a mailbox router is programmed; and

FIG. 4 is a flowchart detailing a method in accordance with the present invention.

### DETAILED DESCRIPTION

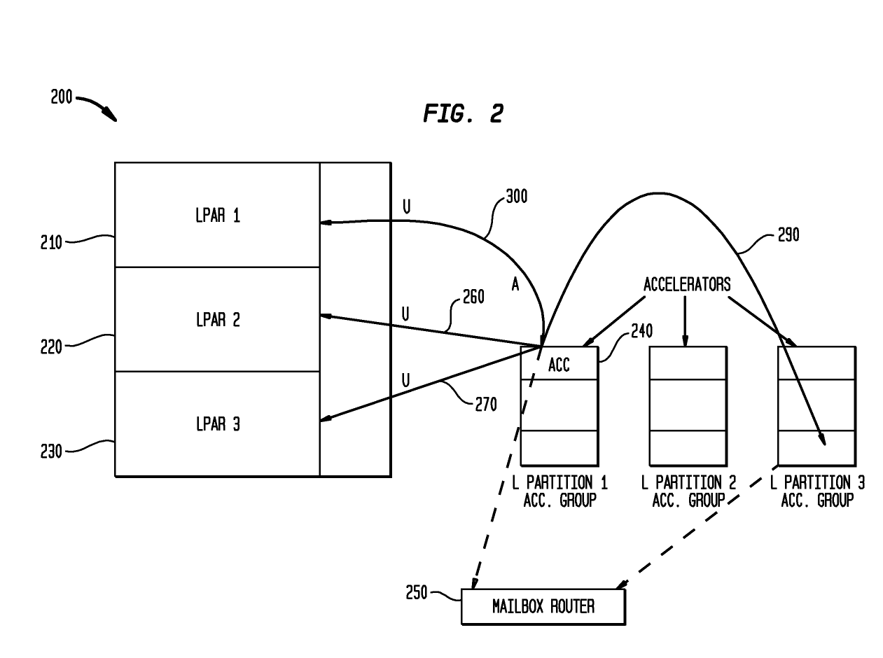

In communication operations between an address space or LPAR and an accelerator attached to an enterprise server, the call pattern can occur in three ways—one-to-one, many-to-one and many-to-many. In a one-to-one pattern, one LPAR/address space calls one accelerator. In a many-to-one pattern, many LPARs/address spaces call the same accelerator function simultaneously and produce a single output. In a many-to-many pattern, multiple LPARs/address spaces call a single accelerator function simultaneously yielding multiple outputs. Thus, successive call-return-communicate patterns with common LPAR/address space producer/consumers can exchange values directly in the accelerator fabric without intervention of the OS or hypervisor. FIG. 2 depicts a communication scheme in accordance with the present invention. As depicted therein, a high performance server 200 is partitioned into LPARs 210, 220 and 230 respectively. In the communication scheme depicted, LPAR 210 registers its communication requirements, along with desired recipients of accelerator output, with mailbox router 250 operating on accelerator 240. The mailbox router 250 is a software abstraction with multiple inputs and multiple outputs. Each input and output is described by a port descriptor consisting of (transaction id, input/output LPAR ID/Accelerator ID, Queue Size, Element Size, QoS policy, Data Movement Method). The mailbox router 250 is placed on an accelerator. The inputs to the mailbox router 250 can be LPARs, address spaces or other mailbox routers corresponding to other accelerator functions. The outputs of a mailbox router can be delivered to address spaces, LPARs and other mailbox routers. QoS policy is a function corresponding to one of a packet scheduler routine, a packet discard routine and a traffic shaping routine. When a QoS policy is specified for an input port, the QoS policy affects the movement of packets from the input port to the output port. A QoS policy can also be specified for an output port. In this case, the policy affects packets being moved from the output port to a server LPAR or another mailbox router. A NULL value in the QoS policy field signifies that no policy is currently under affect.

Data movement method relates to the method used to move data from memory of an address space or LPAR to an input port or from a mailbox router output port to another mailbox router input port or memory of an address space or LPAR. The input ports may “pull” data from a source or a data source may “push” data to the input port. Similarly, an output port may “push” data to a destination or the destination may “pull” data from the output port. In one embodiment of the present invention, the outputs of the mailbox router 250 are implemented using a hybrid polling-interrupt driven approach. This approach can be implemented in two ways. The consumer of an output of the mailbox router 250 can either poll the mailbox router 250 (more inbound traffic, less computational burden on mailbox router 250) or the mailbox router 250 can “shoulder tap” an output consumer (more computational burden on mailbox router) when data is output from the mailbox router 250 and subsequently remotely transmitted as DMA data into the consumer. The former method is optimal for long data and the latter method is optimal for short data.

As depicted in FIG. 2, outputs 260, 270, 290 and 300 are transmitted from mailbox router 250 via accelerator 240. With this arrangement, there is no need to invoke an OS/Hypervisor thereby reducing system latency and enhancing system performance. The mailbox router 250 can deposit short data along 260, 270, 290 and 300 in a timely manner as it can be programmed to deliver data when needed. Without such an abstraction, the short data must be delivered along link 300 to LPAR1 210. After this, LPAR1 210 must write data into inter-partition shared memory or using an OS/hypervisor call to LPAR2 220 and LPAR3 230. The mailbox router 250 also helps long data and streaming data. The mailbox router can be programmed to stream data with required qualities of service to LPAR1 210, LPAR2 220 and LPAR3 230. Without support of a mailbox router, the application in LPAR1 210 must provide streaming support to LPAR2 220 and LPAR3 230 in conjunction with OS/Hypervisor calls/inter-partition shared memory.

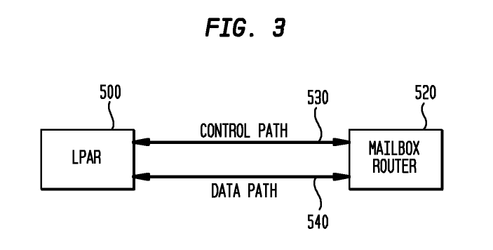

FIG. 3 shows how the mailbox router is programmed. As depicted therein, an LPAR 500 supplies values to program different input and output ports of a mailbox router 520 using control path links 530. Programming a port involves supplying values for each field in the port descriptor. After each port of the mailbox router is programmed along control path links, data values are exchanged along data path links 540.

Mailbox routers are programmed for the duration of a computation and usually are not re-programmed while a computation is in progress. A mailbox router stores input port to output port mapping tables that remain valid for the entire length of the computation. A packet over-ride method allows the header of a packet to encode information regarding an alternative output port or input/output port descriptor information. This allows input/output port mapping information along with input/output port descriptor information to be updated dynamically while a computation is in progress. The packet over-ride method is expected to allow support of system resiliency, load balancing and other architectural-level qualities of service features.

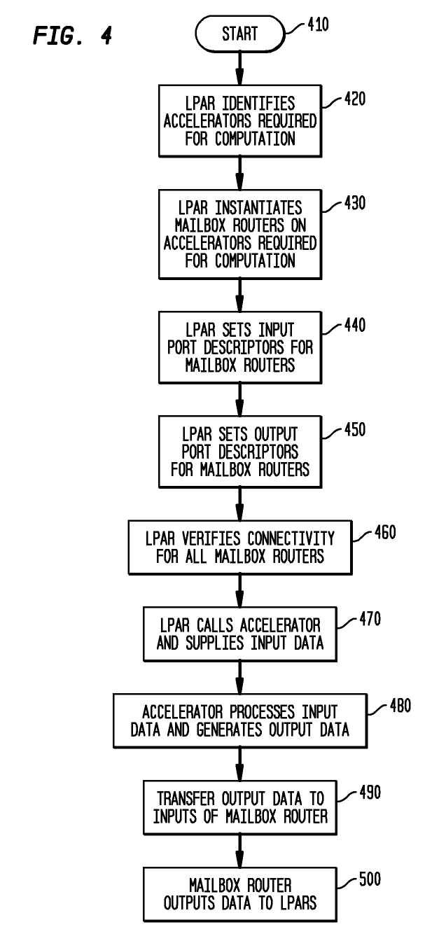

FIG. 4 depicts a method in accordance with the present invention. As depicted therein the method begins with step 410 and flows into step 420 where an LPAR in a high performance server, identifies one or more accelerators required for computation. Next, in step 430, the LPAR instantiates mailbox routers on the accelerators identified in step 420. Then, in step 440 LPAR then sets input port descriptors for all mailbox routers identified in step 430. Step 450 follows wherein the LPAR sets out put descriptors for all mailbox routers identified in step 430. Then, in step 460, the LPAR verifies connectivity for all the identified mailbox routers. Next, in step 470, the LPAR calls the accelerators identified in step 420 and supplies them with input data. The method then flows to step 480 where the accelerator(s) process the input data and generate output data. Step 490 is then executed wherein the output data from the accelerator(s) is passed to pre-configured inputs of the mailbox router identified in step 430. Step 500 is then performed wherein the output data is communicated to LPARs.

It should be noted that the embodiment described above is presented as one of several approaches that may be used to embody the invention. It should be understood that the details presented above do not limit the scope of the invention in any way; rather, the appended claims, construed broadly, completely define the scope of the invention.

1. A method of integrating communication operations comprising:
identifying at least one accelerator for computation;
making a call to the at least one accelerator from at least one logical partition (LPAR);
registering communication requirements and recipient data for the communication to/from the LPAR for the accelerator as input/output port descriptors from/to a mailbox router with input/output ports that are programmed for a duration of the computation and operating on the at least one accelerator, wherein inputs/outputs of the mailbox router comprising at least one of LPARs, address spaces and other mailbox routers;
processing the communication requirements and generating data in the accelerator;
transferring the data to the mailbox router; and
outputting the data from the mailbox router by a polling approach for long data and a shoulder tap approach for short data to transfer the data to at least one of address spaces, LPARs and other mailbox routers.
